(19) United States
(12) Patent Application Publication
(10) Pub. No.: US 2014/0330937 A1
(43) Pub. Date: Nov. 6, 2014

(54) END-TO-END CLASSIFICATION OF STORAGE TRAFFIC STREAMS

(71) Applicant: Microsoft Corporation, Redmond, WA (US)

(72) Inventors: Gregory O'Shea, Cambridge (GB); Thomas M. Talpey, Redmond, WA (US); David Matthew Kruse, Kirkland, WA (US); Eno Thereska, Cambridge (GB); Hitesh Ballani, Cambridge (GB); Thomas Karagiannis, Cambridge (GB); Antony Ian Taylor Rowstron, Cambridge (GB); Richard John Black, Cambridge (GB)

(21) Appl. No.: 13/886,295

(22) Filed: May 3, 2013

(51) Int. Cl. H04L 29/06

(52) U.S. Cl. CPC H04L 65/4069
USPC 709/219

(57) ABSTRACT

Methods of classifying a storage traffic stream in a shared storage network are described. In an embodiment, an identifier for the entity generating the stream is generated, where this entity may, for example, indicate a virtual machine, program, session, physical machine, user or process. The identifier is then shared with at least one processing layer along a path of the storage traffic stream between the generating entity and the storage device which stores the file to which the traffic stream relates. In various embodiments, the identifier may then be used by any processing layers which receive it, to selectively handle traffic streams based on the generating entity. The identifier may be shared when the traffic stream is created or subsequently and in various embodiments, the identifier is shared in a second exchange of messages, following the creation of the traffic stream and prior to any other traffic.

### BACKGROUND

A large data center may contain vast amounts of shared storage and at any time many clients may be accessing these data storage facilities. These clients may be active entities that perform computation using data stored in the data center as input data and/or that store the intermediate or final results of the computation in the data center. Where the resources in the data center are shared (e.g. shared storage servers and the data center network which connects servers), the performance of these clients is unpredictable because it becomes in part dependent upon the amount of contention for these shared resources at the time the computation is performed. Furthermore, aggressive or malfunctioning computations can monopolize shared resources within the data center and seriously compromise the performance of unrelated computations.

The embodiments described below are not limited to implementations which solve any or all of the disadvantages of known storage systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Methods of classifying a storage traffic stream in a shared storage network are described. In an embodiment, an identifier for the entity generating the stream is generated, where this entity may, for example, indicate a virtual machine, program, session, physical machine, user or process. The identifier is then shared with at least one processing layer along a path of the storage traffic stream between the generating entity and the storage device which stores the file to which the traffic stream relates. In various embodiments, the identifier may then be used by any processing layers which receive it, to selectively handle traffic streams based on the generating entity. The identifier may be shared when the traffic stream is created or subsequently and in various embodiments, the identifier is shared in a second exchange of messages, following the creation of the traffic stream and prior to any other traffic.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram showing an example storage system and storage stack;

FIG. 2 is a flow diagram showing an example method of classifying storage traffic streams;

FIG. 3 is a schematic diagram showing various example implementations for the method shown in FIG. 2;

FIG. 4 is a flow diagram showing another example method of classifying storage traffic streams;

FIG. 5 is a flow diagram showing a further example method of classifying storage traffic streams;

FIG. 6 is a schematic diagram showing another example storage stack;

FIG. 7 is a flow diagram showing another example method of classifying storage traffic streams; and

FIG. 8 illustrates an exemplary computing-based device in which embodiments of the methods of classifying storage traffic streams may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, data centers may suffer from variable and unpredictable performance because the time taken to complete a computation which relies upon reading from and/or writing to shared storage facilities will depend upon the contention within the data center at the time the computation is performed. This unpredictability may present a barrier to the adoption and advancement of cloud computing services.

The methods and apparatus described herein enable end-to-end classification of storage traffic streams, where these streams are generated by an entity on a storage client and are destined for a storage device (e.g. a RAID array) within a storage server. A storage traffic stream (e.g. each storage traffic stream) is given an identifier which indicates the generating entity at some level of granularity (e.g. one or more of Virtual Machine, program, process, session and user). The identifier or a message containing the identifier may additionally provide further information as well as identifying the originating entity of the storage traffic stream (e.g. it may include policies to be enforced on the stream). The identifier enables layers within the storage stack (on any device through which the stream passes) to perform operations on the traffic stream, such as delaying packets (e.g. to maintain conformance with Quality of Service agreements), selective virus scanning (e.g. where different levels of scanning are performed based on the source of the traffic stream), etc. on the basis of the originating (or generating) entity.

Although each IO request could be tagged with the identifier (which relates to the stream that the IO request is part of), this may involve changing very large numbers of IO requests (e.g. there may be millions of IO requests to a single data file). A more efficient implementation does not involve tagging each IO request but instead the identifier may be stored associated with information relating to the stream (e.g. in the file stream context, with any IO to that file assuming the classification or identifier of the file).

The operations which are performed on the traffic stream by a layer which receives the identifier may be controlled by policies. The policies may be included within the identifier or the message containing the identifier. Alternatively, the policies may be stored locally to the layer or communicated to the layer via another channel.

The methods may be implemented within a single device (e.g. within a server, which may be the storage client or the storage server) or across the entire system and the identifier may be interpreted by some layers within the storage stack and ignored by others (e.g. by layers which are unable to interpret the identifier). The methods may also be implemented in any size of shared storage solution (i.e. where multiple entities may generate storage traffic streams destined for the same storage server) from small home or Enterprise solutions to large distributed data centers and cloud computing systems.

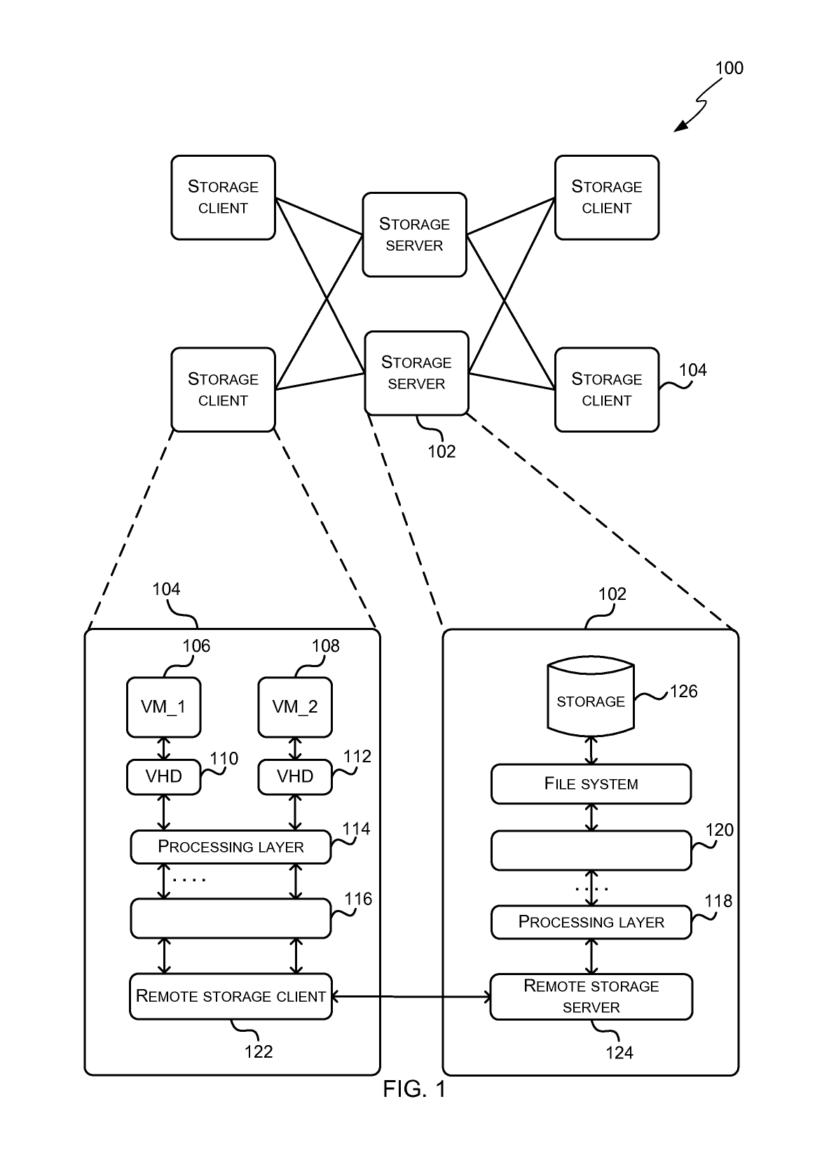

FIG. 1 is a schematic diagram showing an example storage system 100 which comprises a plurality of storage servers 102 which store data and storage clients 104 which run the computations which read from and write to the storage servers 102. Although this diagram shows a many-to-many arrangement (many clients each connecting to many storage servers), the methods described herein are equally applicable to smaller systems (e.g. comprising a single client 104 and a single storage server 102) and many-to-one systems (e.g. comprising one storage server 102 and multiple clients 104) and it will further be appreciated that a system may comprise many more clients and/or servers than shown in FIG. 1. Furthermore, although the elements shown in FIG. 1 are shown as either supporting computation (the storage clients 104) or supporting storage (the storage servers 102), it will be appreciated that in other examples, an element (e.g. one or more of the elements in system 100) may be a server which provides a combination of both storage and computation.

FIG. 1 also shows a typical storage stack within a storage client 104 and a storage server 102. In this example, the storage client 104 is a hypervisor which runs virtual machines (VMs) 106, 108 and uses virtualized storage 110, 112 (virtual hard disks, VHDs). The storage stack comprises a plurality of processing layers 114-120 in both the storage client 104 and the storage server 102 and these processing layers (which may also be referred to as ‘stackable layers’) may implement functionality such as encryption, compression, virus scanning, etc. The remote storage client and remote storage server layers 122, 124 implement a protocol, such as a network file sharing protocol, which supports access to remote storage services. An example of such a protocol is Server Message Block (SMB) and other protocols may alternatively be used (e.g. NFS).

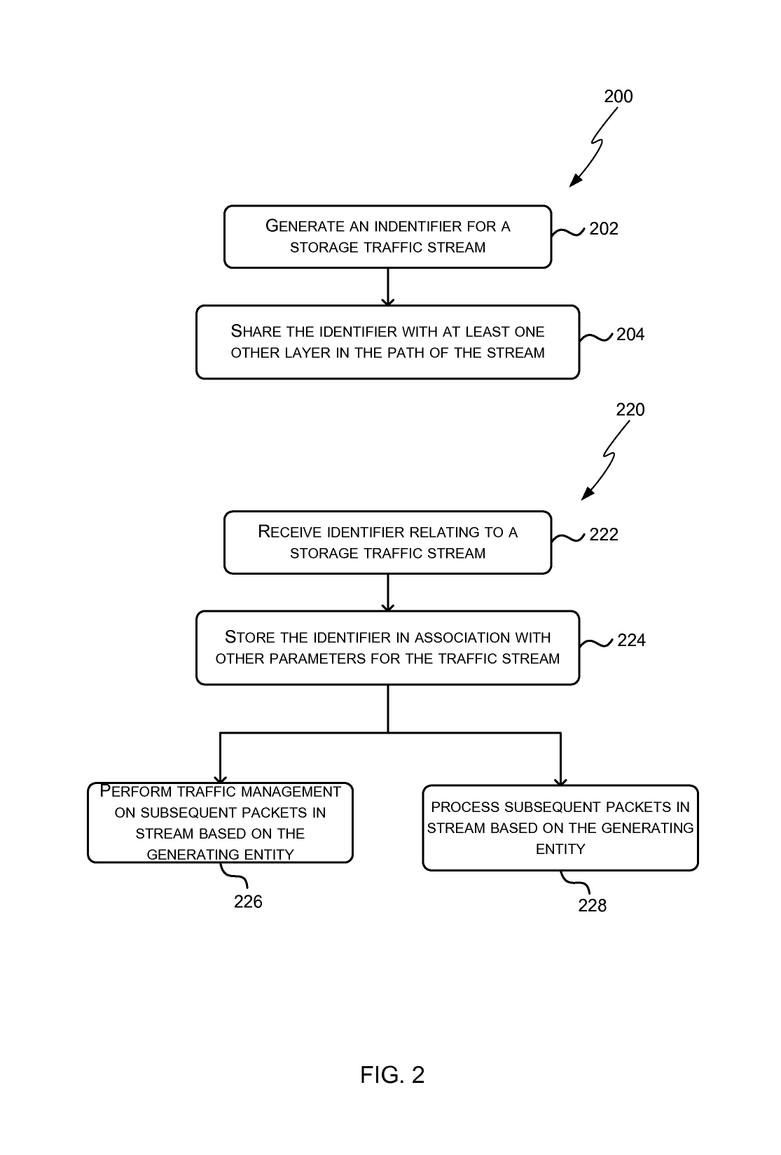

FIG. 2 shows an example method 200 of classifying storage traffic streams which may be implemented in the system 100 shown in FIG. 1. The method comprises generating an identifier for a storage traffic stream, which may also be referred to as a flow, (block 202). The identifier, which is generated (in block 202), identifies an entity generating the stream. This identifier is then shared with at least one layer in the path of the stream (block 204), e.g. with at least one other layer in the path of the stream or with the layer which generated the identifier. The storage traffic stream comprises I/O requests which flow between the VMs 106, 108 and storage 126 and the identifier may be shared with one or more other layers along the path of the stream (e.g. any of layers 114-124 in FIG. 1) and/or within the storage 126.

In some examples, the identifier may be shared (in block 204) by transmitting it along the same path as the storage traffic stream (and this may be referred to as in-band transmission) and in which case the identifier may be shared with all the layers along the path or all the layers along the path that can interpret the identifier. In other examples, the identifier may be transmitted by another route and so may not be received by all the layers. In some examples, the identifier may only be shared within a single device (e.g. within the device that generates the identifier which may be the storage client or the storage server) and in other examples, the identifier may be shared with another device (e.g. identifier may be generated in the storage client 104 and shared with one or more layers in the storage server 102). As described above, the identifier is shared (in block 204) with one or more layers and as demonstrated by the examples described herein, it may be shared with any layer.

The identifier may be shared (in block 204) on creation of the storage traffic stream or subsequent to the creation of the storage traffic stream. In an example described in more detail below, the identifier may be shared after creation of the storage traffic stream but prior to any other traffic. In other examples, an identifier may be shared at any time a stream switches between entities (i.e. where the generating entity or destination of the stream changes) or at any other time in order to control subsequent traffic.

Where the identifier is shared as a part of the message which creates the traffic stream (or flow), this may involve a change to existing protocols. Where the identifier is shared in a second exchange directly after the creation of the storage traffic stream, none of the packets in the stream are modified (i.e. the packets which create the stream and subsequent read/write requests are not modified) and it does not involve any change in existing protocols.

The identifier (generated in block 202) identifies the generating entity (or source) which may, for example, be a VM or set of VMs, program, process (i.e. an instance of a program), session, physical machine, physical network interface, user, etc. The identifier may identify the entity at any level of granularity and make take any form. In an example, a security descriptor (SID) may be used which encodes the identity of the requestor for the data (e.g. it converts the user and VM part of the source to a unique number and this unique number may be obtained through cooperation with a security service within the system 100 that authenticates users, servers and VMs). In a further example, a N-tuple may be used (where N is an integer) which comprises details of the user, the process, the server or VM, the operation being performed on the file (by any entity, e.g. VM, program, process, session or user), the file being accessed and the share (i.e. a location within the storage server where the file is located), i.e. <user, process, server or VM, operation, file, share>. In this example N=6; however, in other examples, a subset (i.e. not all of) the parameters in the 6-tuple may be used (N<6) or there may be additional parameters (e.g. N>6). Where the SID and the 6-tuple is used, the SID may replace the first three elements in the 6-tuple (user, process, server or VM).

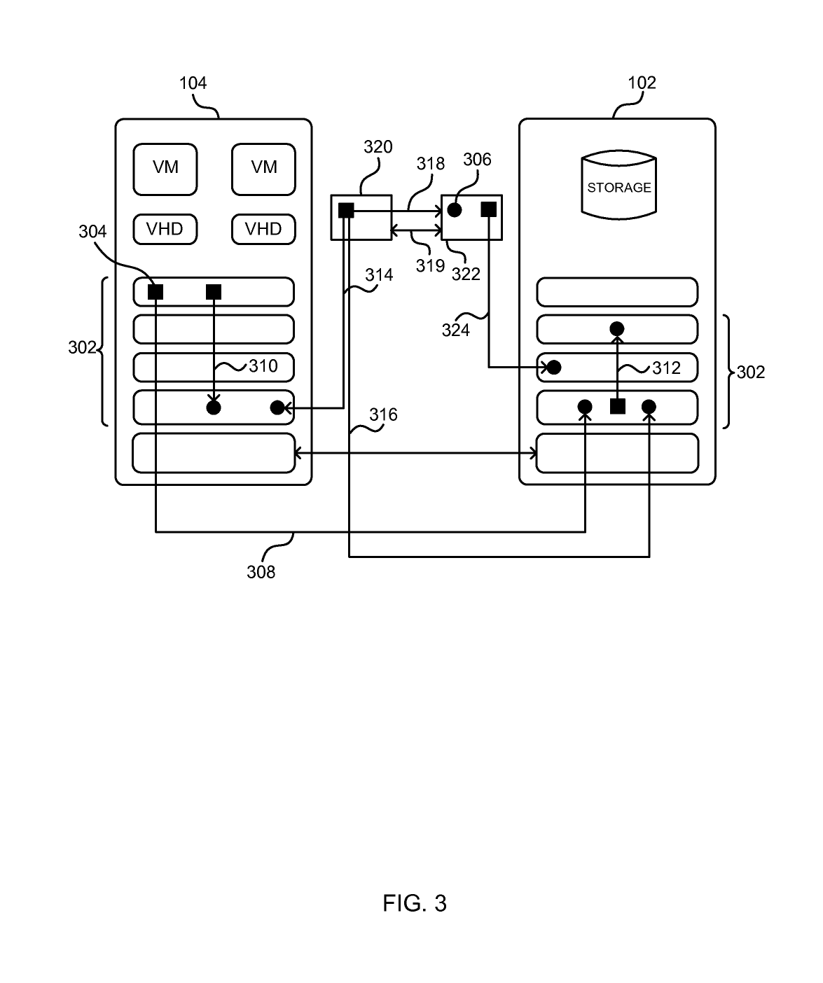

The identifier may be generated (in block 202) by any processing layer within the storage stack or any other entity (e.g. a third party, as described in more detail below, and/or an entity which knows the identity of the generating entity). In an example, the identifier may be generated by processing layer 114 in a storage client 104 and this processing layer 114 may, for example, comprise a filter driver or minifilter driver. Where the processing layer 114 is a minifilter driver it may register callback routines (e.g. preoperation and/or postoperation callback routines) which intercept specified types of I/O operations. In an example, a minifilter driver may register preoperation and postoperation callback routines which intercept a stream of IO requests passing between client applications running on VMs and storage 126 on local or remote storage servers 102. In another example, the identifier may be generated (in block 202) in a processing layer in the storage server 102 and then shared only with processing layers within the storage server 102. Various other examples are described below with respect to FIG. 3. The identifier may be generated at any time and various examples are described below.

FIG. 2 also shows an example method 220 of using the identifier to perform traffic management or selective traffic processing. As shown in FIG. 2, a layer which receives an identifier relating to a storage traffic stream (block 222), stores the identifier in association with other parameters associated with the traffic stream (block 224), where these other parameters may include the file which is being read from or written to. In some examples, the receiving layer may already have stored an identifier for the stream which contains a generic generating entity (which may, for example, be the storage client on which the stream is generated) and this generic identifier may be replaced (in block 224) by the received identifier. Based on the stored identifier, and in many examples based on the generating entity identified within the stored identifier, the receiving layer may then perform some selective traffic management (in block 226) and/or traffic processing (in block 228). As described above, a policy applied to the traffic stream (in block 226 or 228) may also be included within the identifier or within the message containing the identifier.

As described above, the layer which receives and stores the identifier (in method 220) may be any layer in the path of the storage traffic stream. In an example, the layer may be a processing layer 118 within the storage server 102. Similarly to the layer that generates the identifier, this layer may be implemented as a filter driver or a minifilter driver. Various examples are shown in FIG. 3 and described below.

FIG. 3 is a schematic diagram showing various example implementations for the method shown in FIG. 2 and described above. The diagram shows the storage stack in a similar manner to that shown in FIG. 1; however, more processing layers 302 are shown. In FIG. 3, various positions where the identifier may be generated (in block 202) are shown with a square 304 and various positions with which the identifier may be shared (in block 204, and hence received as in block 222) and subsequently stored (in block 224) are shown with a circle 306. The paths traversed by the identifier when it is shared are shown by arrows (between a square 304 and a circle 306).

In a first example (arrow 308), the identifier is generated within a processing layer in the storage client 104 and traverses the same path as the storage traffic stream itself. The identifier is shared with at least one other layer on that path and in this example it is shared with a processing layer in the storage server 102.

In a second example (arrow 310), the identifier is generated within a processing layer in the storage client 104 and again traverses the same path as the storage traffic stream itself; however in this example, the identifier is shared with another processing layer within the storage client 104 and is not shared outside the storage client 104. This arrangement may be described as a classification-aware client and a generic server.

In a third example (arrow 312), the identifier is generated within a processing layer in the storage server 102 and traverses the same path as the storage traffic stream itself within the storage server 102. The identifier is shared with at least one other layer on that path i.e. with another processing layer in the storage server 102. This arrangement may be described as a classification-aware server and a generic client.

In further examples (arrows 314-318), the identifier is generated within a third party entity 320 (which may be a control node) which observes requests within the storage stack (e.g. within the storage client 104) and generates an identifier based on a change in the storage traffic stream. For example, the control node may monitor the requests to identify any new ‘create’ request (i.e. a message to create or open a new storage traffic stream) to a new endpoint (i.e. rather than a second successive create request with the same generating entity and same endpoint). In these further examples (arrows 314-318), the identifier is not shared along the same path as the storage traffic stream and may be shared with a processing layer in the storage client 104 (arrow 314), a processing layer in the storage server 102 (arrow 316) and/or another third party entity 322 (arrow 318), e.g. another control node. Where there are two control nodes 320, 322 these may work together (e.g. as indicated by arrow 318) or they may work independently. Where both control nodes generate identifiers, they may work together and synchronize identifiers (as indicated by arrow 319) or they may work independently (e.g. as indicated by arrows 314 and 322 where each control node generates their own identifiers, shares them with processing layers and does not share them with the other control node). This arrangement may be described as a third-party controlled system.

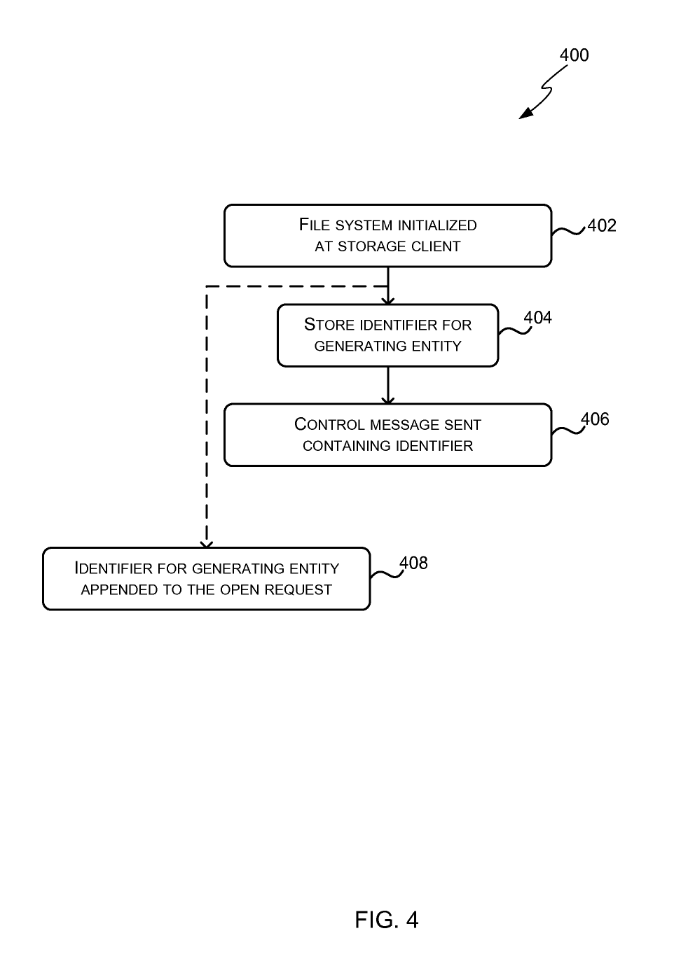

FIG. 4 shows another example method 400 of classifying storage traffic streams which may be implemented in the system 100 shown in FIG. 1. This method 400 may be considered a more detailed implementation of the methods shown in FIG. 2 and described above. In the example shown in FIG. 4, the identifier is shared between a processing layer in the storage client 104 (which generated the identifier) and a processing layer in the storage server 102.

According to the method 400 shown in FIG. 4, when the file system is initialized on the storage client (block 402), identifying information for the generating entity, such as the SID, is stored locally (block 404). This may then be sent, via a second message (e.g. a secondary control message such as an IOCTL system call), to the storage client (block 406).

In a variation of the method 400, also shown in FIG. 4, the identifying information may be sent as part of the message exchange which creates the storage stream (block 408), rather than as a separate exchange after the open operation. In this example, the identifier for the generating entity (e.g. VM 106 or 108 in FIG. 1) is appended to the open call which creates the storage stream.

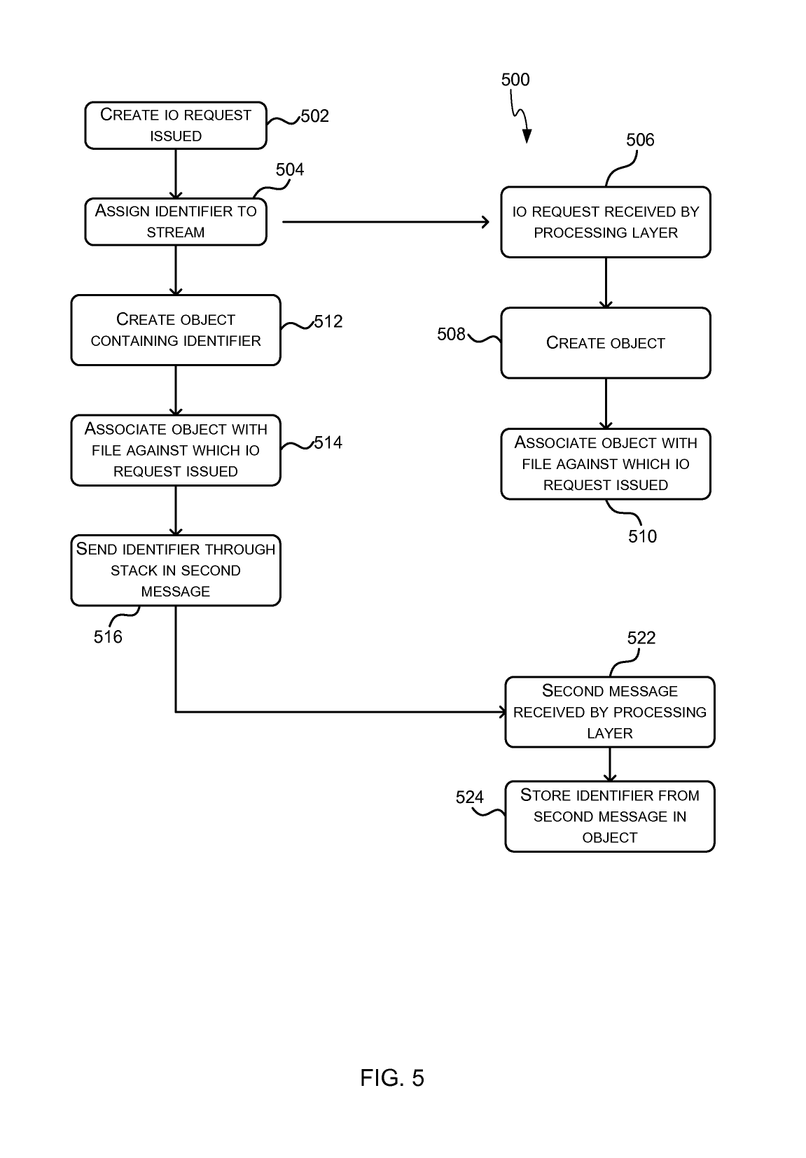

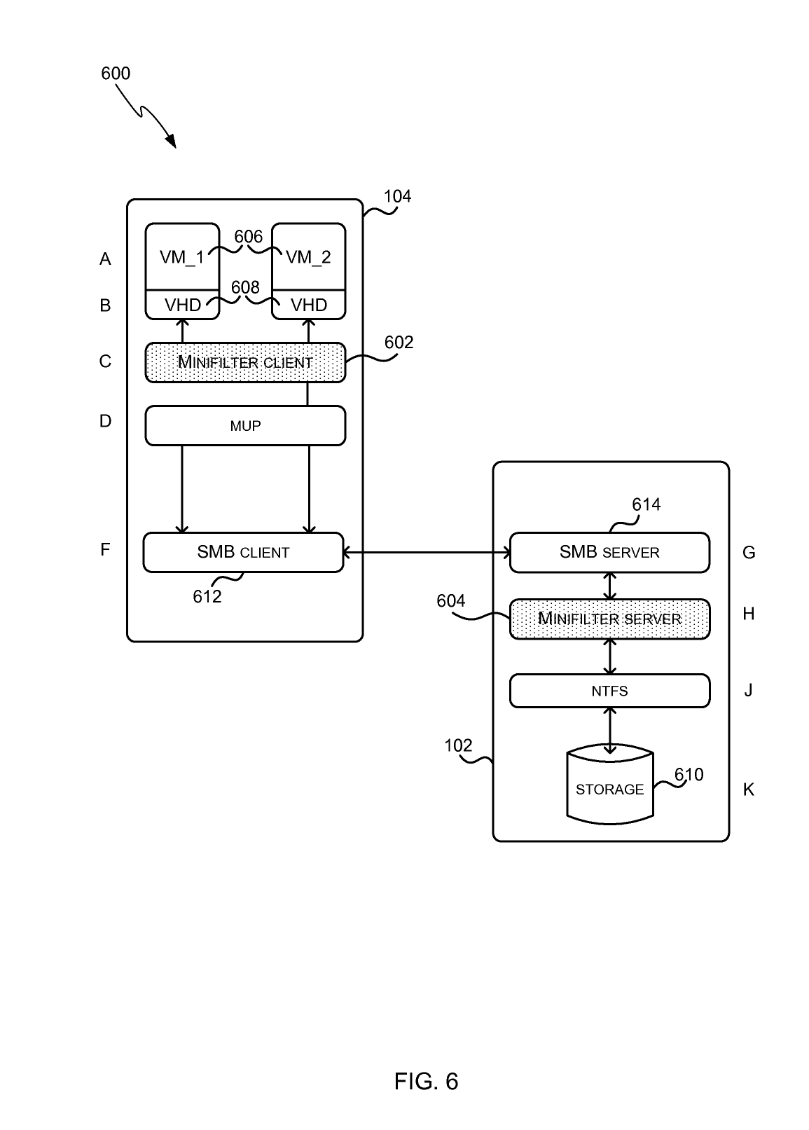

FIG. 5 shows a further example method 500 of classifying storage traffic streams which may be implemented in the system 100 shown in FIG. 1 or in the alternative representation of the storage stack shown in FIG. 6. This method 500 may be considered a more detailed implementation of the methods shown in FIGS. 2 and 4 and described above. In the example shown in FIG. 5, the identifier is shared between a processing layer 602 in the storage client 104 (which generated the identifier) and a processing layer 604 in the storage server 102.

When a VM 606 opens a VHD 608 it treats it as a file and a CREATE (SHARE) request is issued (block 502) which starts to traverse through the storage stack in the form of a CREATE IO request. This CREATE IO request opens the storage stream and creates and opens a file. If the file already exists, it can open the file (without needing to create it first). The CREATE IO request may alternatively be described as a request to initiate access to a file on the storage server. A processing layer 602 in the storage client 104 receives the CREATE IO request, inspects it and assigns an identifier to the traffic stream (block 504), as described above, this identifier indicates the generating entity at some level of granularity. In an example, this may be implemented by a minifilter preoperation routine in the processing layer 602.

A processing layer 604 on the storage server 102 receives the IO request (block 506) and creates an object (block 508), e.g. a “File Stream Handle Context” object. It additionally asks the OS to associate the object it has created with the file against which the IO request was issued (block 510), i.e. the file in the storage 610 which is being read from and/or written to. In an example, this may be implemented using a minifilter postoperation routine running in the processing layer 604.

The processing layer 602 on the storage client 104 also creates an object (block 512), e.g. a “File Stream Handle Context” object, in which it stores the identifier assigned to the request (in block 504). It also asks the OS to associate the object with the file against which the IO request was issued (block 514). Each of the layers 602, 604 now has an object which it has created and which is associated with the file against which the IO request was issued (i.e. the same file for both layers). In an example this may be implemented using a minifilter postoperation routine running in the processing layer 602.

The processing layer 602 on the storage client 104 then communicates the identifier (as assigned in block 504) through the storage stack for the benefit of the processing layer 604 and any other processing layers. This may, in some examples, be implemented using a second message, or secondary control operation, (block 516) which carries the identifier (e.g. an IOCTL or FSCTL). If the second message is associated with the same file as the original IO request (from block 502), it will be routed through the stack along the same path as the original IO request.

When the second message is received by the processing layer 604 within the storage server (block 522), the identifier (contained within the second message) is stored (block 524) within the object for the file (as created in block 508).

For subsequent read and write operations, the object (e.g. the File Stream Handle Context object) is retrieved for the file in question (i.e. the file which is being read from or written to) from which the identifier of the entity (e.g. VM) that is accessing the file is known. As the identity of the originating entity is known, traffic processing or management operations may be performed on a per entity (e.g. per VM) basis in either or both locations.

Although the discussion of FIG. 5 above refers to a CREATE call, it will be appreciated that in some protocols there may be separate ‘open’ and ‘create’ calls or there may be no CREATE call and the methods described above are also applicable to such protocols. In examples where there is no CREATE call (block 502 omitted), the objects (in blocks 508, 512) may be created in response to other triggers (e.g. the start of traffic using a particular filehandle or filename) and/or the object may be persistently cached. In these examples, the second message (as sent in block 516) may still be used to communicate the identifier for the stream.

Although FIG. 6 shows particular locations (within the storage stack) for the processing layers 602, 604, this is by way of example only and these processing layers may be located elsewhere in the stack.

In one example implementation, the storage client 104 may be a Microsoft® Hyper-V® server and the storage server 102 may be a Windows Server®; although in other implementations other servers may be used and these servers may run different operating systems. Furthermore, in some examples, the storage client and storage server may be manufactured by different vendors and each may run a different OS.

Use of a second message as described above enables the method to be implemented without changing existing protocols. In other examples, however, the identifier may be shared in a different way and this may require use of a new or modified protocol.

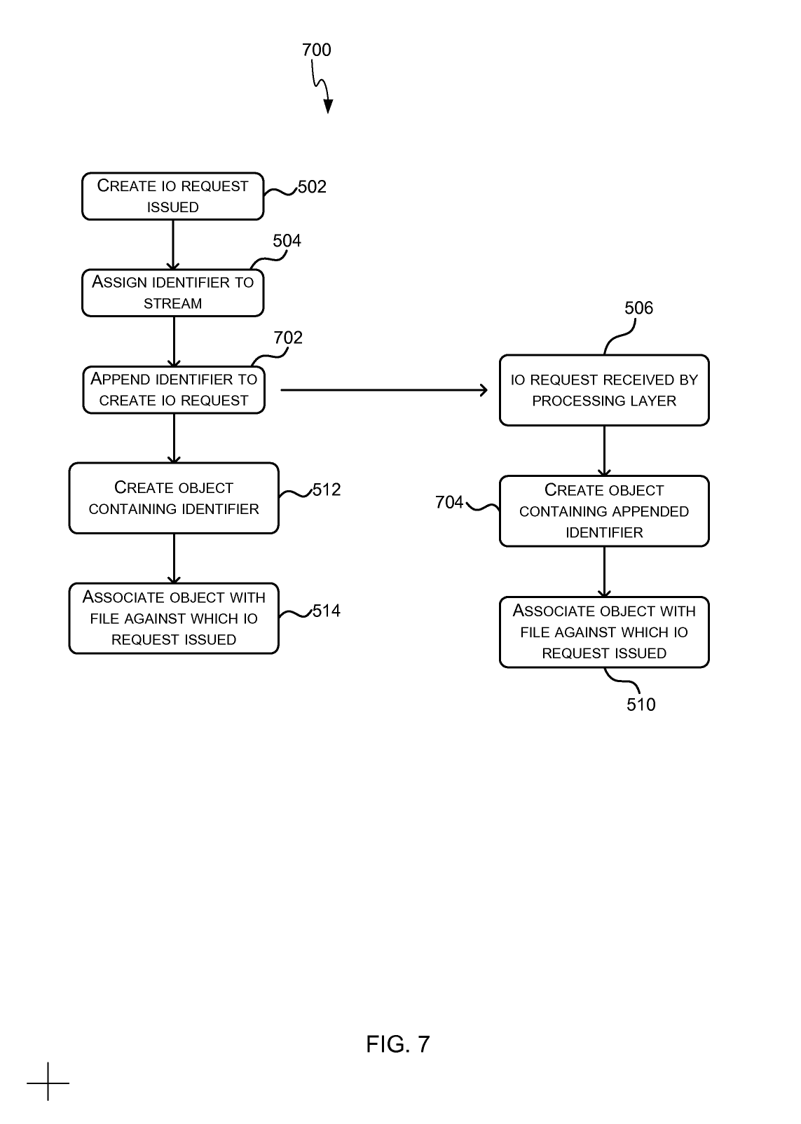

FIG. 7 shows another example method 700 of classifying storage traffic streams which may be implemented in the system 100 shown in FIG. 1 or in the alternative representation of the storage stack shown in FIG. 6. This method 700 may be considered a more detailed implementation of the methods shown in FIGS. 2 and 4 and a variation of the method shown in FIG. 5.

In the method shown in FIG. 7, instead of using a second message to communicate the identifier (as shown in FIG. 5), the CREATE IO request is “decorated” by appending the identifier of the generating entity (block 702).

When the decorated IO request is received by the processing layer (in block 506), an object is created which contains the appended identifier (block 704) and as before the object is associated with the file against which the IO request was issued. This means that both the processing layers (the transmitting layer 602 and the receiving layer 604) have created an object that contains an identifier (blocks 512 and 704) and associated it with the file against which the IO request was issued (blocks 514 and 510). The identifiers in the two objects are the same and both relate to the generating entity.

Although the methods described above relate to a single identifier for a generating entity, in some examples there may be multiple identifiers for a single generating entity and/or one identifier for a plurality of storage traffic streams (which may be generated by the same or different entities). For example, where a generating entity has multiple service level agreements (SLAs) with the operator of the data center, there may be different identifiers for each SLA and then any differential traffic management or operations may be performed based on the identifier which corresponds to both a generating entity and a SLA. In some examples, different identifiers may be used within the same storage traffic stream to identify a specific subset (i.e. not all) of the stream. For example, different identifiers may be used to differentiate between read and write requests that belong to the same stream (and which may have different SLAs).

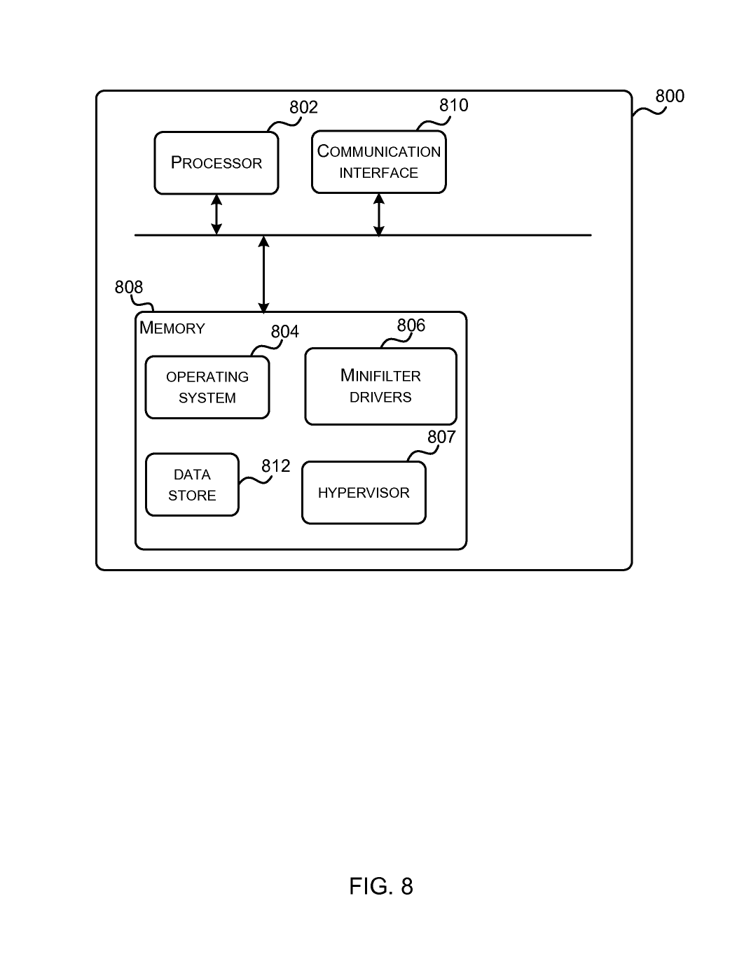

FIG. 8 illustrates various components of an exemplary computing-based device 800 which may be implemented as any form of a computing and/or electronic device, and in which embodiments of the methods described herein may be implemented. The computing-based device 800 may operate as a storage client 104 or a storage server 102.

Computing-based device 800 comprises one or more processors 802 which may be microprocessors, controllers or any other suitable type of processors for processing computer executable instructions to control the operation of the device in order to implement the methods described herein. In some examples, for example where a system on a chip architecture is used, the processors 802 may include one or more fixed function blocks (also referred to as accelerators) which implement a part of the method of generating/sharing/receiving the identifier in hardware (rather than software or firmware). Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

Platform software comprising an operating system 804 or any other suitable platform software may be provided at the computing-based device along with one or more minifilter drivers 806 (or equivalent) arranged to filter IO requests. If the computing-based device 800 operates as a storage client, a hypervisor 807 may be provided to control virtualization and provide the VMs.

The computer executable instructions may be provided using any computer-readable media that is accessible by computing based device 800. Computer-readable media may include, for example, computer storage media such as memory 808 and communications media. Computer storage media, such as memory 808, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 808) is shown within the computing-based device 800 it will be appreciated that the storage may be distributed or located remotely and accessed via a network or other communication link (e.g. using communication interface 810).

Where the computing-based device 800 acts as a storage server, the memory 808 may further provide a data store 812 or separate storage may be provided.

The communication interface 810 enables the computing-based device 800 to communicate with other entities within the storage system. For example, where the computing-based device 800 operates as a storage server, the communication interface 810 is arranged to receive requests from storage clients and where the computing-based device 800 operates as a storage client, the communication interface 810 is arranged to send requests to a storage server.

In some examples, the computing-based device 800 may also comprises an input/output controller arranged to output display information to a display device which may be separate from or integral to the computing-based device 800. The display information may provide a graphical user interface. The input/output controller may also be arranged to receive and process input from one or more devices, such as a user input device (e.g. a mouse, keyboard, camera, microphone or other sensor). In some examples the user input device may detect voice input, user gestures or other user actions and may provide a natural user interface (NUI). In an embodiment the display device may also act as the user input device if it is a touch sensitive display device. The input/output controller may also output data to devices other than the display device, e.g. a locally connected printing device.

Any of the input/output controller, display device and the user input device (where provided) may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The methods described above may be used in any shared storage system to manage or otherwise selectively process streams of storage traffic (e.g. where the selectivity of processing is based on the generating entity of a stream). In an example, storage traffic streams from a trusted generating entity may bypass a virus checking operation whilst storage traffic streams from other generating entities must undergo the virus checking operation. Another example application for the methods, which may prevent a shared storage system from failing or having very poor performance, is in the case of live migration of VMs from one storage client to another. This is a very bandwidth intensive operation which requires some form of traffic management or traffic throttling so that the operation of the data center does not fail. Using the method shown in FIG. 7, by way of example (and the method of FIG. 5 or other methods described herein may alternatively be used), an initial CREATE IO request may be decorated (in block 702) with an identifier that identifies the traffic as a live migration traffic stream as well as identifying the generating entity. This identifier is also received at other processing layers in the storage stack (in block 506) and included within an object created and associated with the file against which the IO request is issued. So from the outset any receiving processing layers that can interpret the identifier are aware that the traffic stream comprises live migration traffic and the stream may then be processed/managed in a special way (e.g. rate limited) such that it does not significantly impact the other traffic within the data center. In further example applications, the identifier may include other priority information (e.g. to flag low priority IOs) as well as the generating entity information.

Although the present examples are described and illustrated herein as being implemented in a particular system with particular hardware which may use one OS, the system described is provided as an example and not a limitation. As those skilled in the art will appreciate, the present examples are suitable for application in a variety of different types of shared storage systems. Furthermore, although the identifier is described above as being used by a processing layer which is different from the layer generating the identifier, in some examples, the identifier may be used by the same layer that generated the identifier (e.g. on subsequent read/write operations).

The methods described herein provide classification of storage traffic streams based on the generating entity, where that entity may be defined in many different ways and at different levels of granularity. The classification may be end-to-end or may be within a single server (e.g. as shown in the various examples of FIG. 3). This classification may be used in any way and for any purpose. In an example, the methods enable a data center operator to moderate competition for shared resources (e.g. so that commercial agreements with its customers can be upheld and/or so that the shared storage network's performance does not fall to unacceptable or unusable levels). Through the classification methods described herein, resource limits and priorities may be afforded to the most urgent computations, so that aggressive behavior by other computations does not compromise their performance.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset, i.e. such that a subset is not equal to the set and necessarily excludes at least one member of the set.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of classifying a storage traffic stream comprising:
generating, in a computing device, an identifier for a storage traffic stream, the identifier identifying an entity generating the stream; and
sharing the identifier with at least one processing layer along a path of the storage traffic stream between the generating entity in a storage client and a data store in a storage server.

2. A method according to claim 1, wherein the computing device generating the identifier is the storage client.

3. A method according to claim 2, wherein sharing the identifier with at least one layer along a path of the storage traffic stream between the generating entity in a storage client and a data store in a storage server comprises:
sharing the identifier with at least one layer in the storage client.

4. A method according to claim 2, wherein sharing the identifier with at least one layer along a path of the storage traffic stream between the generating entity in a storage client and a data store in a storage server comprises:
sharing the identifier with at least one layer in the storage server.

5. A method according to claim 1, wherein the computing device generating the identifier is the storage server and wherein sharing the identifier with at least one layer along a path of the storage traffic stream between the generating entity in a storage client and a data store in a storage server comprises:
sharing the identifier with at least one layer in the storage server.

6. A method according to claim 1, wherein the computing device generating the identifier is a third party control node and wherein sharing the identifier with at least one layer along a path of the storage traffic stream between the generating entity in a storage client and a data store in a storage server comprises:
sharing the identifier with at least one layer in the storage client or storage server.

7. A method according to claim 1, wherein generating an identifier for a storage traffic stream comprises:
storing a current identifier for the generating entity on creation of the traffic stream.

8. A method according to claim 1, wherein the identifier identifies at least one of a user, a process, a program, a session and a virtual machine generating the storage traffic stream.

9. A method according to claim 8, wherein the identifier further identifies at least one of: an operation, a file being accessed by the storage stream and a location within the storage server where the file is located.

10. A method according to claim 1, wherein sharing the identifier with at least one layer along a path of the storage traffic stream between the generating entity in a storage client and a data store in a storage server comprises:
sending a request to initiate access to a file on the storage server;
sending a second message comprising the identifier, the second message being associated with the file on the storage server.

11. A method according to claim 10, wherein the second message comprises one or more of an IOCTL and a FSCTL.

12. A method according to claim 10, wherein the second message is sent following the request to initiate access to a file on the storage server and prior to any other requests relating to the file.

13. A method according to claim 10, wherein the second message is arranged to cause the at least one layer to store the identifier in an object associated with the file on the storage server.

14. A method according to claim 1, wherein sharing the identifier with at least one layer along a path of the storage traffic stream between the generating entity in a storage client and a data store in a storage server comprises:
appending the identifier to a request to initiate access to a file on the storage server.

15. A method of classifying a storage traffic stream comprising:
receiving, at a computing device, an identifier relating to a storage traffic stream, the identifier identifying an entity generating the traffic stream; and
storing the identifier in association with a file to which the storage traffic stream relates.

16. A method according to claim 15, further comprising, performing selective traffic management or processing on the storage traffic stream based on the stored identifier.

17. A method according to claim 15, further comprising, prior to receiving the identifier:
receiving a request to initiate access to the file;
creating an object and associating the object with the file;
and wherein storing the identifier in association with a file to which the storage traffic stream relates comprises:
storing the identifier in the object associated with file.

18. A method according to claim 15, wherein the identifier identifies at least one of a user, a process, a program, a session and a virtual machine generating the storage traffic stream.

19. A system comprising a storage client device, the storage client device comprising:
a processor;
a communication interface arranged to communicate via a network with at least one storage server; and
memory arranged to store device executable instructions, which when executed cause the processor to:
provide a plurality of virtual machines;
issue a request to access a file on the storage server, the request being associated with one of the virtual machines;
store an identifier for the virtual machine associated with the request; and
send a secondary control message comprising the identifier, the secondary control message being associated with the file on the storage server.

20. A system according to claim 19, further comprising the storage server, the storage server comprising:
a processor;
a communication interface arranged to communicate via a network with the storage client device; and
memory arranged to store device executable instructions, which when executed cause the processor:
in response to receiving a request to access a file on the storage server, to create an object and associate it with the file; and
in response to receiving a subsequent control message associated with the file, to retrieve the object and to store an identifier from the control message in the object, the identifier identifying the virtual machine associated with the request to access a file on the storage server.
